(19) United States
(12) Patent Application Publication
(10) Pub. No.: US 2012/0121782 A1
(43) Pub. Date: May 17, 2012

(54) Conveyor Toaster with Self-Aligning Belts

(75) Inventors: Loren Veltrop, Chicago, IL (US); Charles B. Hartfelder, LaGrange Park, IL (US); Brian W. Mathews, Waterman, IL (US)

(73) Assignee: PRINCE CASTLE LLC, Carol Stream, IL (US)

(21) Appl. No.: 12/947,898

(22) Filed: Nov. 17, 2010

(51) Int. Cl. A47J 37/08; A21D 8/00

(52) U.S. Cl. 426/505; 99/386

(57) ABSTRACT

A hybrid food heating device (100) includes a first conveyor toaster, which toasts one side of a food product, and a second conveyor toaster device, which toasts two sides of a food product. The second conveyor toaster device uses a rib attached to the inside surface of a continuously rotating belt to keep the belt from running sideways on the runners.

### FIELD OF THE INVENTION

This invention relates to apparatus utilized in the heating of food products such as bread-type food products, including buns, rolls, croissants, bagels, muffins, and the like, as well as pasta, vegetables, cakes, pastries, and so forth.

### BACKGROUND OF THE INVENTION

Restaurants often heat bread-type food products that range from bread slices to buns, rolls, croissants, bagels, and the like. Such heating may include warming, toasting or browning. Toasting and browning requires heating a food product to produce a Maillard reaction.

A Maillard reaction usually requires heat and is a chemical reaction between an amino acid and a reducing sugar. As an example, when bread is placed in a toaster, the Maillard reaction causes the outer layer of carbohydrates and proteins to combine. The result is browned, i.e., toasted bread.

At times, it may be desired or necessary to brown or toast different parts of a food product differently, although the food product is desired to be completed or assembled at the same time. For example, a club-type sandwich includes a bun with a top, a center, and a bottom. Such a sandwich often requires the top, bottom and center to be toasted, with the center or club section being toasted on both sides. Toasting all three parts of such a bun in the same amount of time is problematic because it is difficult to simultaneously toast both sides of a club section. Accordingly, there is a need for a heating device that can heat multiple parts of a food product so that all components are heated in substantially the same amount of time.

### BRIEF DESCRIPTION OF THE DRAWINGS

FIG. 1 is a perspective view of a hybrid food heating/toasting device;

FIG. 2 is a perspective of the right-hand side of the device shown in FIG. 1, with an access door open to show two counter-rotating conveyor toasters;

FIG. 3 is a second perspective of the right-hand side of the device shown in FIG. 1, with the access door open to show two counter-rotating conveyor toasters and two conveyor belts removed from the conveyors;

FIG. 4 is a perspective view of the left side of a conveyor assembly;

FIG. 5 is a perspective view of a conveyor, with its frame removed and a depiction of a heated platen;

FIG. 6 is a front elevation of the device shown in FIG. 5;

FIGS. 7A, 7B and 7C depict different cross sectional shapes for a belt alignment rib;

FIG. 8 is an isolated view of a groove formed into one end of a roller, the alignment rib-receiving groove formed into the roller has a cross section that is configured to receive an alignment rib having a circular or semi-circular cross section; and

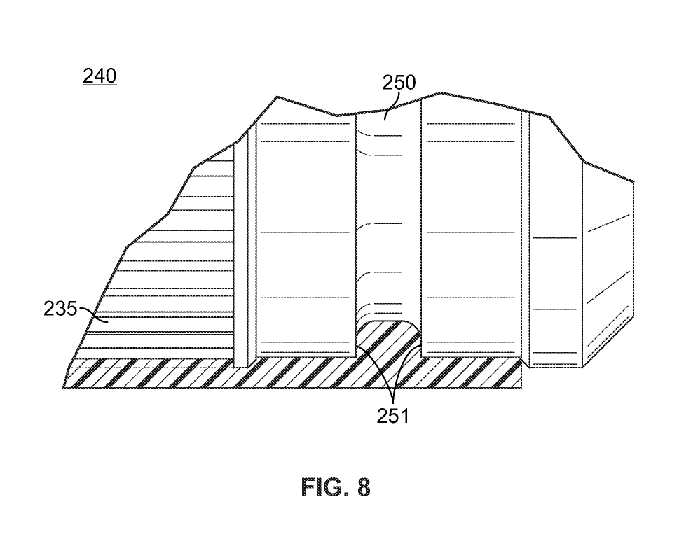

FIG. 9 shows the long arms of L-shaped user actuating arms in the full down position with user actuating tabs fixed against the sides of the frames of the conveyors.

### DETAILED DESCRIPTION

The following describes an apparatus for and a method of heating food products that include buns, rolls, croissants, bagels, muffins, flatbread, pitas, and the like, as well as pasta, vegetables, cakes, pastries, and so forth. Meat and meat products can also be heated.

The terms heat and heating mean, to make warm or hot. The term “heating food products” means to make food products warm or hot. The terms, heat, heating and heating food products include heating a food product to a temperature at which the food product is toasted. As used herein, toast, toasted and toasting all refer to heating a food product to make it crisp, hot, and/or brown by heat or heating.

It is well known that toasted bread products have a distinctly different flavor and color than do the same products prior to toasting. Toasting also changes a bread product's color and its texture. Toasting and toasted bread products also give off a pleasing aroma. Toasting and its effects are the result of the aforementioned Maillard reaction.

Toasting is well-known to be a non-enzymatic reaction between carbohydrates and proteins that occurs upon heating. Food products that have relatively smooth surfaces are preferably toasted by contact heating. Food products like English muffins that have relatively rough surfaces are preferably toasted using infrared (IR) energy, such as the IR emitted from electrically-heated filaments used.

The disclosed apparatus is a hybrid conveyor toaster apparatus, which provides two toasters in a single cabinet. A first conveyor toaster performs single-sided heating, i.e., heating of one, single side of a food product. A second conveyor toaster, which forms part of the cabinet, is able to heat opposite sides of a food product, such as both sides of a slice of bread, simultaneously, i.e., at the same time. The hybrid toaster thus toasts both sides of a bread product, such as the middle or “club” section of a hamburger bun in the same amount of time, or substantially the same amount of time required to toast single sides of the top and bottom sections of the same bun. The top, bottom and club sections of a three-section hamburger bun can therefore be toasted in the same amount of time, or in substantially the same amount of time, regardless of whether the middle bun or club section is slightly thinner or thicker. The two toasters can also be used separately and independently, one-at-a-time.

A conveyor toaster that can toast one side of a bun or other bread product is disclosed in the Applicant's co-pending patent application Ser. No. 12/433,660. The '660 application was filed on Apr. 30, 2009, and is entitled, “Toaster With Removable and Adjustable Conveyors.” (Attorney docket no. 3015.043.) It is assigned to the same entity as this application is. The entire contents of U.S. patent application Ser. No. 12/433,660 are incorporated herein by reference.

A two-sided conveyor toaster able to toast both sides of a food product at the same time is described below. By empirically adjusting the speeds of the conveyors in each toaster, and/or empirically adjusting the temperatures of the heated platens, both sides of the middle or “club” section of a multi-tier hamburger bun can be toasted in the same amount of time required to toast one side of the top and bottom portions.

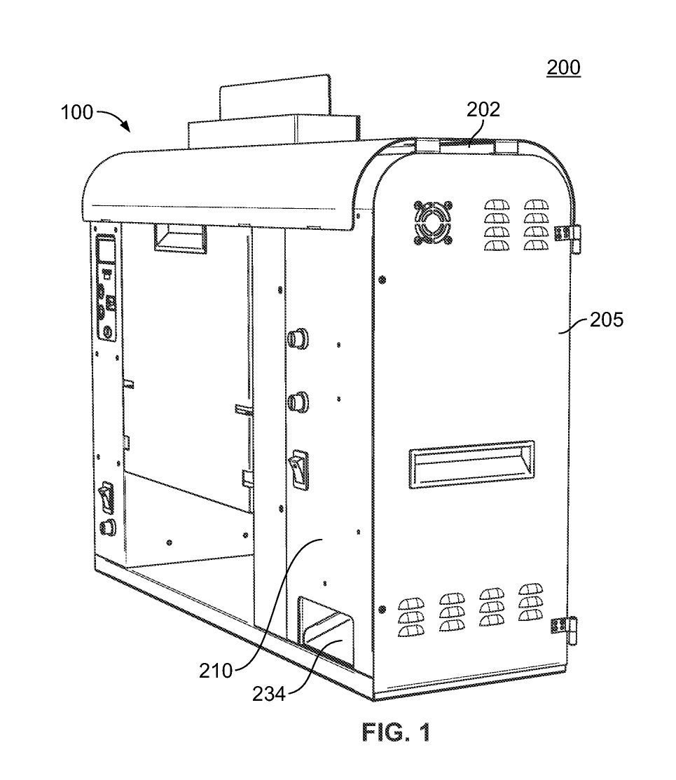

Paraphrased, the '660 application discloses a toaster having a platen with two sides. Conveyors face each sides of the platen and are configured to drag a food product over the sides of the platen. The surface of a food product in contact with one side of the platen or the other is thus heated. If the surface temperature of the platen is high enough and the conveyor speed is selected appropriately, the food product will be toasted when it drops away from the platen. The hybrid heating apparatus 200 shown in FIG. 1 includes the toasting apparatus 100 disclosed in the '660 application as well as a dual conveyor heating apparatus 200 described below.

In a preferred embodiment, the conveyors in the two toasters are mechanically coupled together. Their speeds are therefore mechanically synchronized to each other.

Food products to be toasted on both sides are dropped into a rectangular-shaped opening 202 located at the top and at one end of the device 200. The rectangular opening 202 is not visible in the figure but it is also not germane to the invention disclosed and claimed hereinafter.

Both sides of a food product dropped into the opening 202 are toasted on both sides by the conveyors disclosed below. The food product exits the cabinet from an opening 234.

When the two heating devices are used to toast foods, toasting time and toasted color of the two-sided toaster 200 can be adjusted to match the toasting time and toasted characteristics of food products toasted in the companion food heating device such that the toasting time and color of food products that pass through both toasters are consistent.

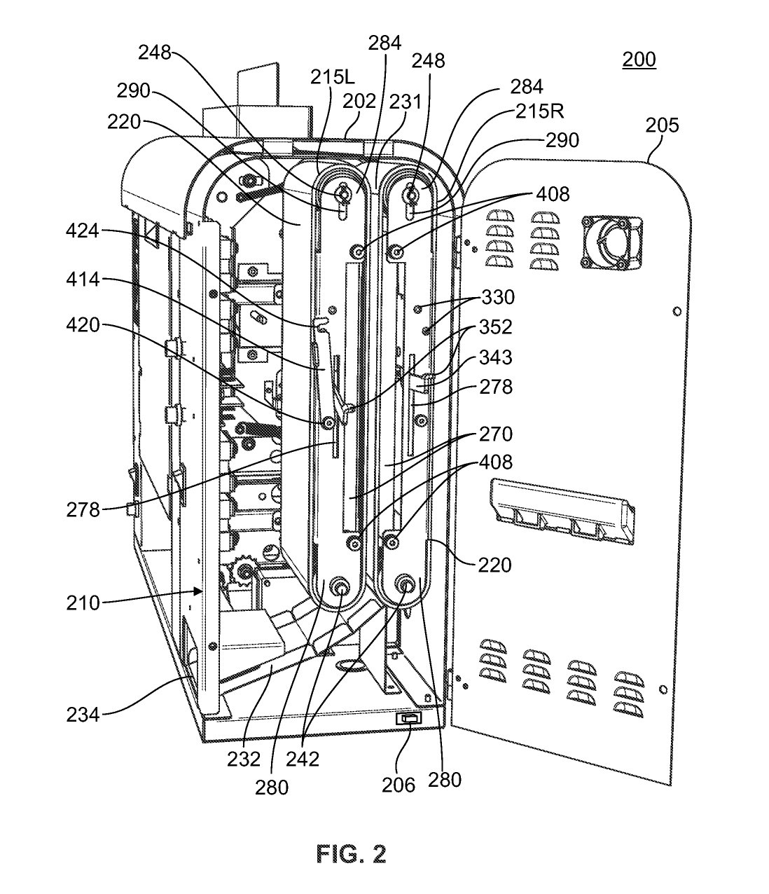

FIG. 2 is a perspective view of the heating device 200 with an access door 205 opened to reveal two, counter-rotating toasting conveyors 215L and 215R. The conveyors 215L and 215R are separated from each other by a distance 231 selected to be slightly less than the thickness of a food item to be toasted on both sides by being passed between the two conveyors 215L and 215R. The conveyor spacing distance 231 is selected to ensure that a food product dropped into the opening 202 will be slightly compressed between the conveyors and thus “grabbed” by the conveyor belts 220 and pulled through them.

Virtually all materials are thermally-conductive and, thermally-conductive belts for use with conveyor toasters and are known in the art. For purposes of this disclosure, thermally-conductive materials are also considered to include Teflon®.

Each of the conveyors 215L and 215R is comprised of a continuous, thermally-conductive belt 220. In one embodiment, the belt 220 is preferably made entirely of Teflon®. In one embodiment, layers of Teflon® that are formed by skiving are layered on top of each other with the “grain” orientation of successive layers orthogonal to each other. In any case, the belt preferably has a non-stick coating, such as Teflon® on the outside or second surface 228 of the belts 220, to facilitate the food product's release from the conveyors and discharge from the device.

The belts 220 are flexible, continuous and have a width that corresponds to the widths of two, cylindrically-shaped rollers that the belts 220 ride over. Food products that pass between the conveyors 215L and 215R fall onto a discharge slide 232 and exit the cabinet through an opening 234.

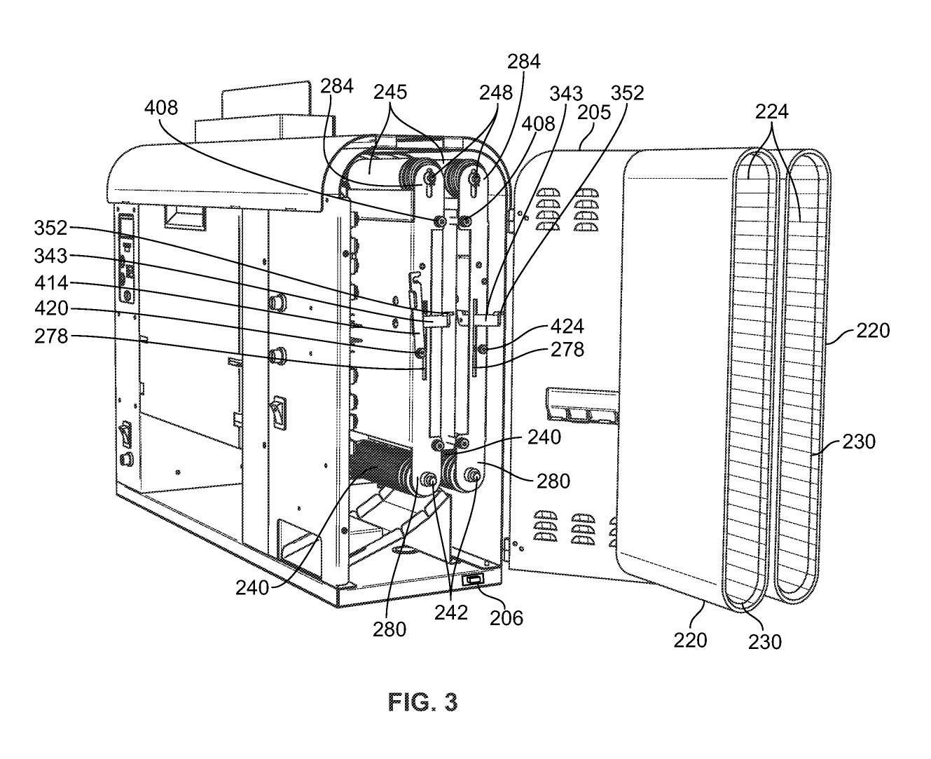

FIG. 3 is a perspective view of the two-sided heating/toasting device 210. The conveyor belts 220 are shown as being removed from the conveyors 215L and 215R in order to show components of each of the conveyor mechanisms 215L and 215R, including among other things, a belt tensioner mechanism, which is described below.

A well-known and unfortunate characteristic of roller-driven belts is their tendency to wander toward one end of a roller when the axes of the rollers are not perfectly parallel to each other and/or if the two rollers are not perfectly cylindrical. A belt alignment rib is provided to the inside surface of the belts, which rides in mating grooves that are formed into the rollers. The rib and grooves overcome the tendency of a belt to wander on the rollers by applying a counterforce to the belt when the belt starts to wander sideways on the rollers.

As can be seen in FIG. 3, the inside surface 224 of each belt is provided with an alignment ridge or rib 230. The rib 230 is preferably continuous around the inside surface 224 of the belt 220. In an alternate embodiment, the alignment rib 230 is not continuous around the inside surface but is instead segmented or “toothed.” In such an alternate embodiment, relatively short sections of rib material extend around the inside surface but are separated from each other by small spaces. For claim construction purposes, both embodiments of the rib are considered to be equivalent and encompassed by the terms, rib, alignment rib and belt alignment rib.

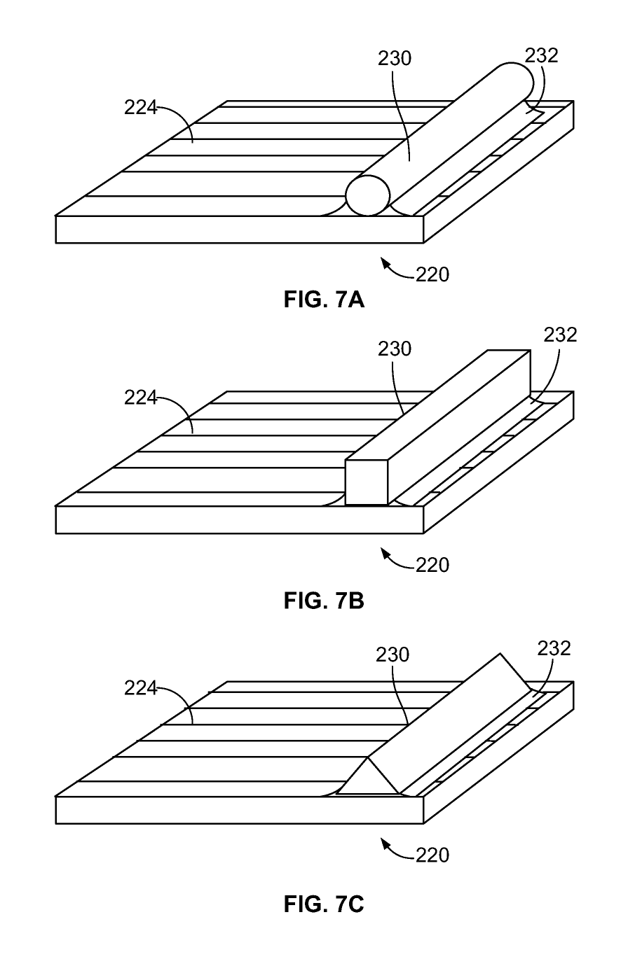

FIGS. 7A, 7B and 7C are isolated, perspective views of the underside of the belt. They also show different equivalent embodiments of different ribs, i.e., ribs 230 with different cross sectional shapes. The rib 230 in FIG. 7A has a circular cross section. The rib 230 in FIG. 7B has a rectangular cross section. The rib 230 in FIG. 7C has a triangular cross section. FIGS. 7A, 7B and 7C also show the relative location of the belt alignment rib 230 on the inside surface 224 to be adjacent to the edge of the belt. The terms rib and belt alignment rib include all of the rib embodiments depicted in FIGS. 7A, 7B and 7C, and variants thereof. The rib 230 is preferably located along one edge of a belt 220, substantially as shown in FIGS. 7A-7C in order to facilitate belt installation around the two cylindrical rollers.

The alignment rib 230 can be made from neoprene rubber, nitrile, polyurethane, urethane or other materials that are both flexible and able to withstand the temperatures used to toast food products. In a preferred embodiment, the rib is embodied as an O-ring belt having a circular cross section as shown in FIG. 7A and which is attached to the inside surface of the belt 220 using either an adhesive 232 such as “B” stage epoxy or silicone, which require moderate heat to cure. Adhesives that include cyanoacrylates do not require heat can also be used to attach the rib but their use is problematic because of their relatively low viscosity.

As mentioned above, the belt's inside surface 224 is optionally provided with corrugations 235, which can extend across the width of the inside surface. Alternate embodiments of the corrugations 235 extend part way across the width of the belt 220. Both embodiments of the corrugations facilitate the belt's frictional engagement with a motor-driven drive roller 240. They reduce belt slippage over the drive roller 240.

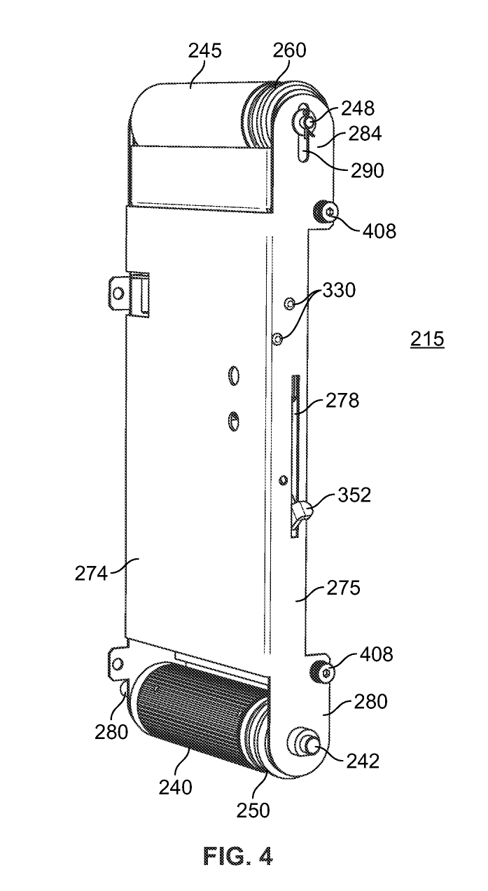

As shown in FIG. 4, one roller 240 is motor-driven. It applies a rotational torque to the belt 220, which encircles the platen. The drive roller 240 is motor driven and causes the belt 220 to rotate around the slave roller 245 and across the surface of a heated platen 400 as the belt 220 rotates on the rollers. Toasting characteristics can thus be controlled by controlling platen temperature and/or belt rotation speed.

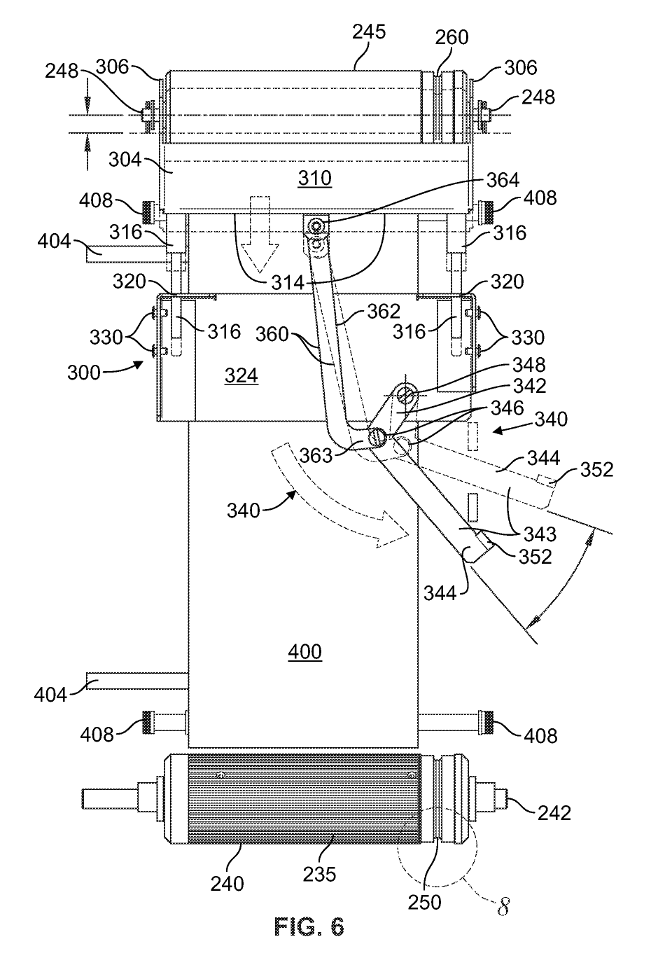

The drive roller 240 rotates around an axle 242, which is centered on the axis of rotation for the roller 240. The circumferential groove 250 that receives the rib 230 is formed into the drive roller 240 near one edge of the drive roller 240. The preferred location of the groove 250 is near the edge of the roller, substantially as shown in FIG. 6, which facilitates belt removal and installation.

The rollers 240 and 245 are rotatably mounted at opposite ends of a metal frame 274. Opposite ends of the frame 274 are formed with elongated tabs, which support the axles 242 and 248 of the two rollers 240 and 245. The lower tabs 280 extend downwardly from the frame 274 and are provided with through-holes (not visible in FIG. 4) that receive the drive roller axle 242. The upper tabs 284 extend in an opposite direction and are provided with elongated slots 290. The slots 290 are configured to allow the slave roller axle 245 to move up and down (as shown in the figure) relative to the drive roller 240. The slave roller axle 248 is thus able to move up and down in the slots 290, which enables the slave roller 245 to move up and down in order to facilitate the removal and installation of a belt 220 around the rollers as well as the tensing of the belt 220. Tension is therefore maintained on the belt 220 to keep the belt 220 in frictional engagement with the drive roller 240.

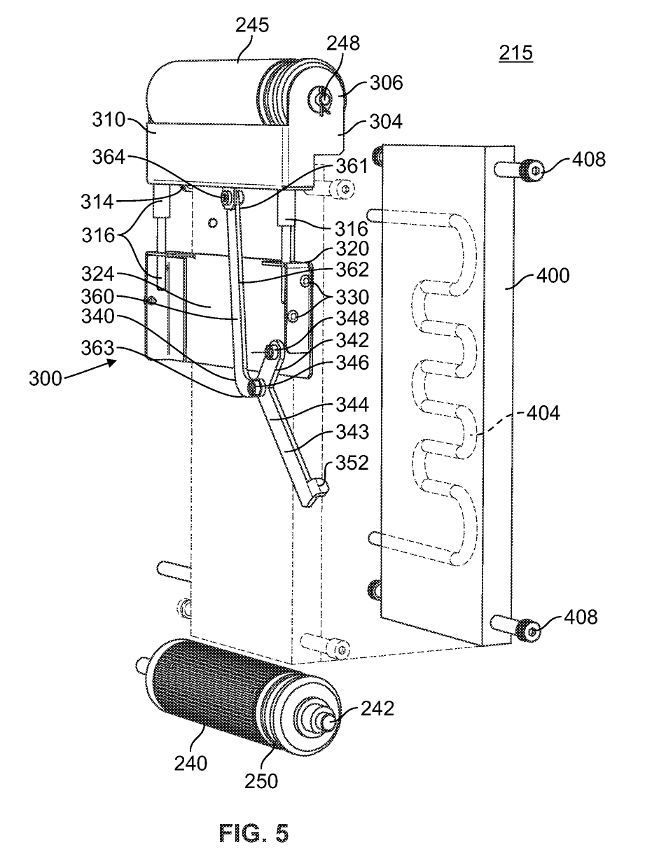

FIG. 5 is a perspective view of a conveyor 215 with the frame 274 removed. It is also a partially-exploded view that reveals the heated platen 400, which makes contact with the inside surface 224 of the belt 220 as the belt 220 rotates around the rollers 240 and 245 of the conveyor mechanism 215. FIG. 6 is a front elevation view of the device shown in FIG. 5. FIG. 5 and FIG. 6 show the operation of a belt tensioning mechanism.

Referring to both FIG. 5 and FIG. 6, the axle 248 of the slave roller 245 is rotatably mounted in a roller bracket 304. The roller bracket 304 is itself sized and shaped to fit freely inside the two upper tabs 284 of the conveyor frame 274. The roller bracket 304 is provided with tabs 306 that extend upwardly from the roller bracket body 310. Two alignment legs 316 extend downwardly from the bottom face 314 of a roller bracket body 310. The shape these, is reminiscent of a rectangular parallelepiped. The alignment legs 316 pass freely through corresponding holes 320 in a belt tensioner bracket 324. The belt tensioner bracket 324 is fixedly attached to sides 275 of the frame 274 of the conveyor assembly 215 by fasteners 330, such as rivets, machine screws and nuts or sheet metal screws.

The fasteners 330 fixedly attach the belt tensioner bracket 324 to the frame 274 of the conveyor assembly 215. The alignment legs 316 pass freely through holes 320 in the belt tensioner bracket 324 but are themselves rigidly attached to the roller bracket 304. The roller bracket 304 is free to move up and down with respect to the belt tensioner bracket 324.

A belt tensioning lever assembly 340 is comprised of a user actuating arm 344 having a shape reminiscent of the upper-case Arabic letter L. The L-shaped user arm 344 has a relatively short leg 342 and a relatively long leg 343. The two legs are substantially orthogonal to each other and joined to each other at a connection point or vertex 346.

The short leg 342 extends between the aforementioned vertex 346 and a distal end 348 thereof. The distal end 348 of the short leg 342 is rotatably attached to the belt tensioner bracket 324.

The vertex 346 of the L-shaped user arm 344 also provides a rotatable connection to one end of a short leg 363 of a substantially L-shaped roller bracket driving arm 360, which also has a long leg 362. The short leg 363 of the roller bracket driving arm 360 is rotatably attached to the user arm 344 at the aforementioned vertex 346. The distal end 361 of the second or long leg 362 of the L-shaped roller bracket driving arm 360 is rotatably attached to the middle of the bottom face 314 of the translatable roller bracket 304.

The arrows in FIG. 6 that are drawn with broken lines show that the L-shaped user actuating arm 344 can rotate through an angle around the pivotal attachment at the distal end 348 of the short leg 342 of the user actuating arm 344. Those of ordinary skill in the art will also recognize from the arrows in FIG. 6 that a counter-clockwise rotation of the user actuating arm 344 around the pivot joint located at the distal end 348 will “pull” the roller bracket driving arm 360 downwardly, which will also pull the roller bracket assembly 310 and the slave roller 245 attached to it, downwardly as well. Conversely, clockwise rotation of the user actuating arm 344 will drive the slave roller 245 upwardly. As the user actuating arm 344 rotates between its up and down travel limits, its horizontal projection from the side 275 of the conveyor will increase and decrease accordingly.

Close inspection of FIG. 2 shows the two long arms 343 of the L-shaped user actuating arms 344 of the two conveyors 215L and 215R at slightly different elevations. FIG. 2 also shows a belt tension safety latch 414 having a pivot point 420 on the left-side conveyor 215L, upright so that its engagement slot 424 is clearly visible.

FIG. 3 shows the long arms 343 of the two L-shaped user actuating arms 344 at the same elevation and extending nearly horizontal from a slot 278 in the side 275 of the frame 274. The belt tension safety latch 414 is depicted as being upright with its engagement slot 424 clearly visible.

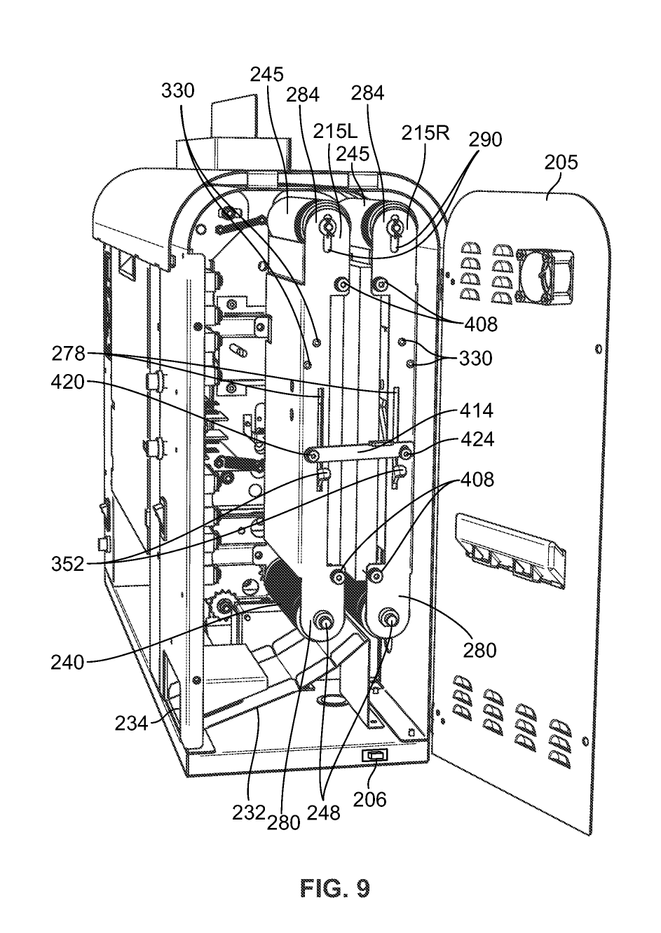

FIG. 9 shows the long arms 343 of the two L-shaped user actuating arms 344 in the full down position with the user actuating tabs 352 against the side 275 of the frame 274. The belt tension safety latch 414 is horizontal with the slot 424 engaged onto a dowel that extends outwardly from the side of the right-hand conveyor 215R.

The length of the long arm 343 and the location of the pivot point 348 are selected such that if the user actuating arm 344 is not in a full-up position or a full-down position the door panel 205 will not close. If the door 205 is not closed, an electric power interlock switch 206 disconnects the device 200 from its electric power source and thus disables the device 200. Downward force impressed on the user actuating arm from the weight of the slave roller and belt will tend to drive the user actuating arm upwardly and away from the side 275 of the frame 274. Closing the door 205 and enabling the device 100, therefore requires a user to push both actuating arms 344 to the full down position, i.e., where the user tabs 352 are against the side 275 of the frame 274 and locking the arms 344 down using the belt tension safety latch 414. FIG. 9 shows the belt tension safety latch 414 down and locked in place.

FIG. 5 shows the heated platen 400 that is used inside each conveyor belt 220 to heat foods that pass through the device, i.e., between the two conveyors 215L and 215R. The platen 400 is heated using an electrically resistive wire, to a temperature that is high enough to toast bread products.

The platen 400 has an electrically resistive heating element 404 embedded within it. The platen 400 is supported in the frame 274 by elongated stand-offs 408, the ends of which are fastened to the sides 275 of the frame 274 of the conveyor 215. The stand-offs 408 are elongated and surrounded by air. This enables them to dissipate heat from the platen that would otherwise be conducted from the platen 400 into the frame 274.

The thermally-conductive belts 220 preferably have a non-stick coating. The food that passes between the two conveyors 215L and 215R is static relative to the belts 220. The food that passes between the two conveyors 215L and 215R is dynamic relative to the platen 400. As a result, heat transfer rate from the platen 400, through the belt 220 and into the food is higher. Food sticking is also reduced.

Those of ordinary skill in the art will recognize that the hybrid combination of a conveyor toaster that toasts a single side of a bread product in combination with a toaster capable of toasting two sides of a product enable a method for toasting different types of bread products at the same time. More particularly, the hybrid combination of a one-sided toaster with a two-sided toaster enables a method for toasting both sides of the club section of a bun in the same amount of time required to toast one side of the top and/or bottom of the bun. Such a method is comprised of adjusting the speed of different conveyors that draw the food product over different heated platens. In a preferred embodiment, the conveyors 215L and 215R are driven by the same motive force that drives the conveyor of a one-sided toaster. The conveyors 215L and 215R also rotate at the same speed as the conveyors of the one-sided toaster. The conveyor speed is adjusted in combination with the platen temperatures such that both sides of a club section are toasted in the same amount of time required to toast one side of either the top or bottom sections of the same bun.

Those of ordinary skill in the art will recognize that the slave roller 245 can be configured without a belt alignment groove 260. The alignment rib 230 can be sized, shaped and located on the inside surface 224 of the belt 220 to run along an edge of one end of the slave roller 245.

Brackets, stands, and electrical connections for the conveyors and platens (not shown) are known in the art. The rollers of the conveyors may be closer together or further apart than shown in the drawings. The claims and claim limitations should be construed accordingly. Although the heating device is shown in a vertical position, it may also be horizontally disposed.

The heating device as set forth herein has many advantages, including heating all sides of the food products as required in the same, or nearly the same, time period. The counter space necessary for the heating device is minimized. The conveyors may be optimally used to reduce the size of the heating device. Use of thermally-conductive belts result in a simple heating device that is easy to use. By use of a conveyor belt that is in static contact with the food product, the heat transfer rate is higher and food sticking is reduced.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A food heating device comprising:
a first, thermally-conductive belt having first and second sides and a first, belt-alignment rib on the first side.

2. The food heating device of claim 1, further comprising:
a first drive roller disposed on the first side of the first, thermally-conductive, belt, the first drive roller having a circumferential slot, which receives said first belt-alignment rib;
a first slave roller disposed on the first side of the first, thermally-conductive, belt; and
a first heated platen disposed on the first side of the first, thermally-conductive belt;
wherein the first heated platen is encircled by the first, thermally-conductive belt and wherein the first belt-alignment rib and circumferential slot maintain the first, thermally-conductive belt on the rollers.

3. The food heating device of claim 2, wherein the slave roller is comprised of a circumferential slot, which receives said first belt-alignment rib.

4. The food heating device of claim 2, further comprising a belt tensioner mechanism, configured to provide a tension to said thermally conductive belt.

5. The food heating device of claim 2, wherein the belt tensioner mechanism is comprised of a user actuating arm operable between first and second positions and which is sized, shaped and arranged to prevent the food heating device from operating if the user actuating arm is not in the first position.

6. The food heating device of claim 5, wherein the user actuating arm is configured to prevent a door panel from closing when the user actuating arm is not in the first position.

7. The food heating device of claim 1, wherein the rib is continuous and extends around the first side of the belt.

8. The food heating device of claim 1, wherein the rib is segmented and extends around the first side of the belt.

9. The food heating device of claim 1, wherein the rib has a substantially circular cross section.

10. The food heating device of claim 1, wherein the rib has a substantially semi-circular cross section.

11. The food heating device of claim 1, wherein the rib has a substantially rectangular cross section.

12. The food heating device of claim 1, wherein the rib has a substantially triangular cross section.

13. The food heating device of claim 1, wherein the rib has a substantially trapezoidal cross section.

14. The food heating device of claim 2, wherein the drive roller is additionally comprised of corrugations.

15. The food heating device of claim 2, further comprised of:
a single-sided toaster operatively coupled to said food heating device, the single-sided toaster being configured to toast one side of a bread product, the single-sided toaster being comprised of:
a toaster having a conveyor that faces one sides of a heated platen and which drags a food product over the side of the platen;
wherein the food heating device is configured to heat first and second sides of a sandwich bun club section in substantially the same amount of time that the single-sided toaster heats one side of at least one of a top section and a bottom section of the sandwich bun.

16. A food heating device comprising:
a first, thermally-conductive belt having first and second sides, the first side having a first, belt-alignment rib;
a first drive roller disposed on the first side of the first, thermally-conductive belt, the first drive roller having a circumferential slot, which receives said first belt-alignment rib;
a first slave roller disposed on the first side of the first, thermally-conductive belt and having a second circumferential slot, which receives said first belt-alignment rib;
a first platen disposed on the first side of the first, thermally-conductive belt;
a second, thermally-conductive belt having first and second sides, the first side of the second belt having a second, belt-alignment rib;
a second drive roller disposed on the first side of the second, thermally-conductive belt, the second drive roller having a third circumferential slot, which receives said second belt-alignment rib;
a second slave roller disposed on the first side of the second, thermally-conductive belt and having a fourth circumferential slot, which receives said first belt-alignment rib; and
a second platen disposed on the first side of the second, thermally-conductive belt;
wherein the first and second belt-alignment ribs and the circumferential slots maintain the first and second thermally-conductive belts in alignment with the first and second platens respectively.

17. The food heating device of claim 16, further comprising:
a first belt tensioner mechanism operatively coupled to the first slave roller, and configured to tense the first thermally-conductive belt;
a second belt tensioner mechanism operatively coupled to the second slave roller, and configured to tense the second thermally-conductive belt.

18. The food heating device of claim 17, further comprising a belt tensioner safety latch operatively coupled to the first and second belt tensioners and which is configured to disable the operation of the food heating device.

19. The food heating device of claim 16, wherein the first and second belts are separated from each other by a predetermined distance and the first and second belts rotate in opposite directions, relative to each other.

20. The food heating device of claim 16, wherein the predetermined distance is less than an average thickness of a food product to be heated.

21. The food heating device of claim 16, further comprised of:
a single-sided toaster operatively coupled to said food heating device, the single-sided toaster being configured to toast one side of a bread product, the single-sided toaster being comprised of:
a toaster having a conveyor that faces one sides of a heated platen and which drags a food product over the side of the platen;
wherein the food heating device is configured to heat first and second sides of a sandwich bun club section in substantially the same amount of time that the single-sided toaster heats one side of at least one of a top section and a bottom section of the sandwich bun.

22. A method of toasting the surfaces of the sections of a bun comprised of a top section, bottom section and a center club section, top and bottom sections having one side to be toasted, the center club section having two sides to be toasted, the method including the steps of:
heating at least one of the top and bottom sections of the bun in a first conveyor toaster comprised of a first thermally-conductive belt, which draws the at least one of the top and bottom sections over a first heated platen; and
simultaneously heating both sides of the club section in a second conveyor toaster comprised of two, counter-rotating thermally-conductive belts, which draw the sides of the club section over spatially separated, second and third heated platens that face each other.

23. The method of claim 22, further comprising the steps of:
adjusting the speed of the conveyor in the first conveyor toaster to be substantially equal to the speed of the two, counter-rotating thermally-conductive belts in the second conveyor toaster.

24. The method of claim 22, further comprising the step of:
adjusting the temperature of the first heated platen;
adjusting the temperatures of the second and third heated platens;
wherein the temperature of the first heated platen and the temperature of the second and third heated platens are adjusted to effectuate a Maillard reaction.

25. The method of claim 22, wherein the first thermally conductive belt and the second and third conveyor belts rotate at substantially the same speed.

26. The method of claim 22, wherein the at least one of the top and bottom sections of the bun and the club section are heated for substantially the same amount of time.
